(19) United States
(12) Patent Application Publication
(10) Pub. No.: US 2013/0119588 A1
(43) Pub. Date: May 16, 2013

(54) CUTTING AND WELDING TORCH

(71) Applicant: FU-TI CHEN, Kaohsiung City (TW)

(72) Inventor: FU-TI CHEN, Kaohsiung City (TW)

(21) Appl. No.: 13/295,083

(22) Filed: Nov. 13, 2011

(51) Int. Cl. B23K 7/00; F23D 14/46; B23K 5/00

(52) U.S. Cl. 266/48; 431/350

(57) ABSTRACT

A cutting and welding torch includes a base. The base is provided with a chamber. Oxygen and a fuel gas are introduced and mixed in the chamber. A mixing pipe is connected to the chamber. The other end of the mixing pipe is connected to a burner nozzle. The interior of the chamber is provided with a check ring. Both sides of the check ring are provided with a sealing gasket respectively. The check ring is made into a hollow cylindrical body by powder alloys. The inside of one end of the mixing pipe adjacent to burner nozzle is provided with a guiding piece. The guiding piece is an elongate metallic piece and twisted to form a spiral piece. A mixed gas of the oxygen and the fuel gas flows along a spiral path of the guiding piece. By this arrangement, a backfire is prevented and the efficiency in operation is increased.

### FIELD OF THE INVENTION

The present invention relates to a cutting and welding torch, and in particular to a cutting and welding torch, which is capable of preventing a backfire and increasing the efficiency in operation.

### DESCRIPTION OF PRIOR ART

During a metal machining process, a cutting and welding torch is often used in cutting or welding a metallic workpiece. FIG. 1 is a cross-sectional view showing the structure of a cutting and welding torch in prior art. In the conventional cutting and welding torch 10 shown in FIG. 1, oxygen and a fuel gas (such as acetylene or hydrogen) are introduced and mixed in a mixing pipe 11. Then, the mixed gas of the oxygen and the fuel gas is exhausted via a burner nozzle 12 for combustion, thereby generating a high-temperature flame for cutting or welding the metallic workpiece.

The conventional cutting and welding torch 10 can cut or weld the metallic workpiece during the metal machining process. However, after the oxygen and the fuel gas are mixed in the mixing pipe 11 and exhausted via the burner nozzle 12 for combustion, the thus-generated flame may flow back into the mixing pipe 10 to generate a backfire. Further, the conventional cutting and welding torch 10 is not provided with an element for blocking the flame from flowing back to the mixing pipe 11. As a result, a gas explosion may be generated easily to endanger an operator of the torch if the operator does not shut off the supply of the fuel gas immediately.

### SUMMARY OF THE INVENTION

In order to solve the above problems, an objective of the present invention is to provide a cutting and welding torch, which is capable of preventing the backfire and increasing the efficiency in operation.

In order to achieve the above objective, the present invention is to provide a cutting and welding torch, which includes a base. The base is provided with a chamber. Oxygen and a fuel gas (such as acetylene or hydrogen) are introduced and mixed in the chamber. One side of the chamber is formed with an opening. A locking cover is provided on the opening. A mixing pipe is connected to the chamber. The other end of the mixing pipe is connected to a burner nozzle. The interior of the chamber is provided with a check ring. Both sides of the check ring are provided with a sealing gasket respectively. The check ring is made into a hollow cylindrical body by powder alloys. The inside of one end of the mixing pipe adjacent to burner nozzle is provided with a guiding piece. The guiding piece is an elongate metallic piece and twisted to form a spiral piece. A mixed gas of the oxygen and the fuel gas flows along a spiral path of the guiding piece.

By this arrangement, the cutting and welding torch of the present invention is capable of preventing a backfire and increasing the efficiency in operation.

### BRIEF DESCRIPTION OF THE DRAWINGS

FIG. 1 is a cross-sectional view showing the cutting and welding torch in prior art;

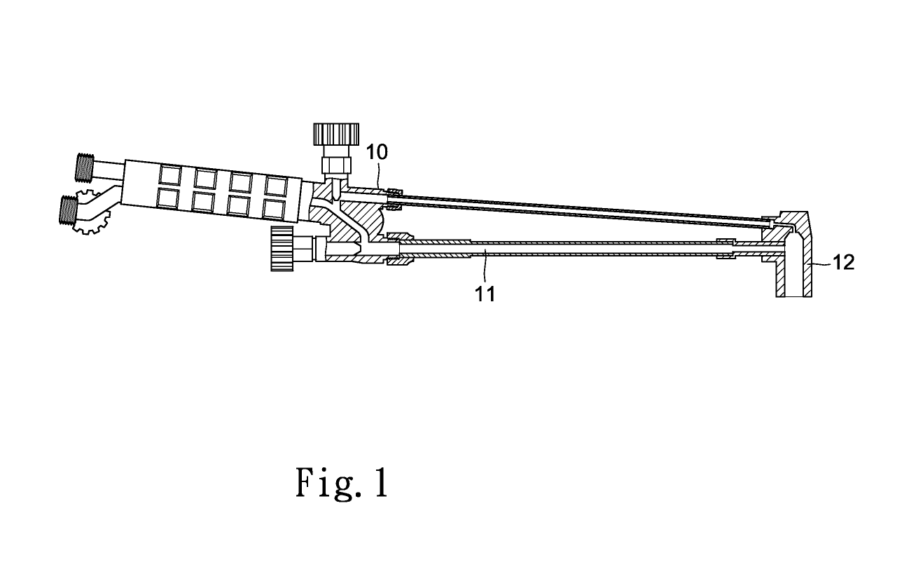

FIG. 2 is a perspective view of the present invention;

FIG. 3 is a cross-sectional view of the present invention;

FIG. 4 is a perspective view showing the guiding piece of the present invention; and

FIG. 5 is a cross-sectional view of the present invention showing the flowing of a mixed gas.

### DETAILED DESCRIPTION OF THE INVENTION

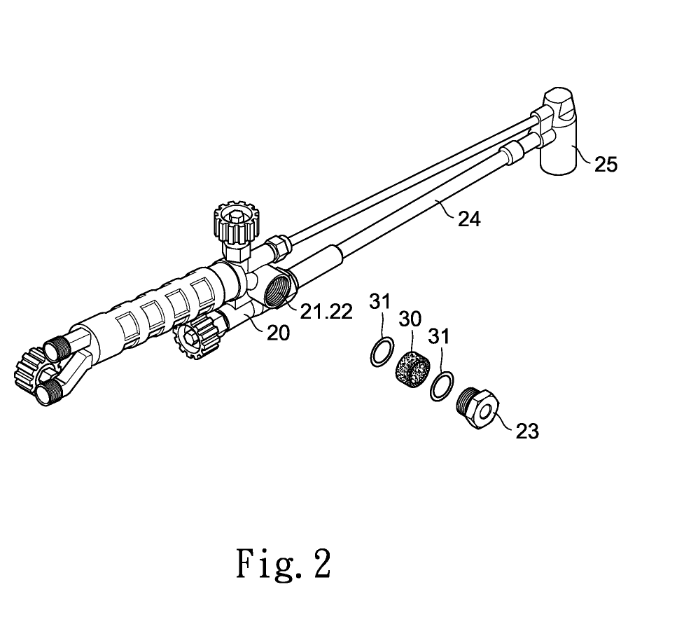

The technical measures and structure of the present invention for achieving the above objectives will be described in more detail with reference to a preferred embodiment thereof together with FIGS. 2 to 5.

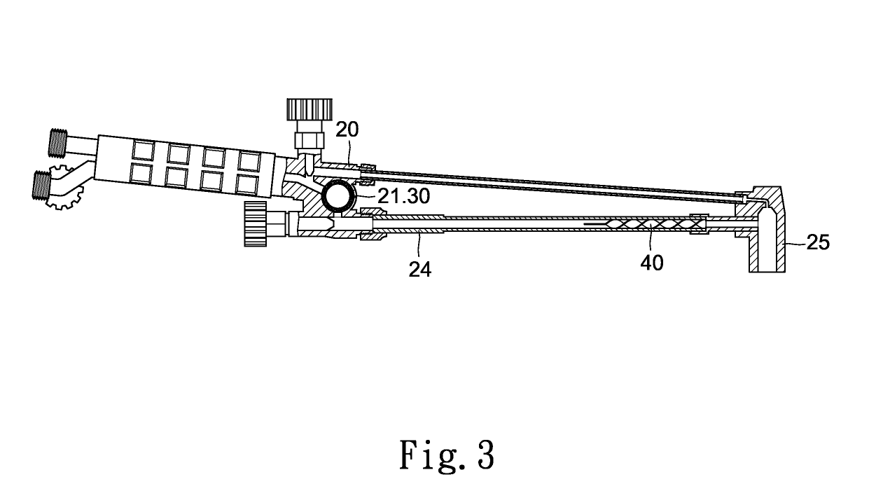

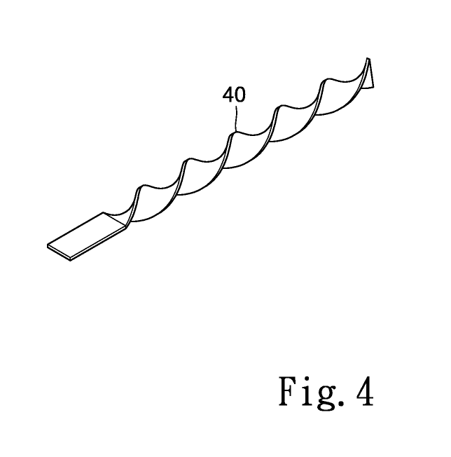

As shown in FIGS. 2 and 3, the present invention provides a cutting and welding torch, which includes a base 20. The base 20 is provided with a chamber 21. The chamber 21 allows oxygen and a fuel gas (such as acetylene or hydrogen) to be introduced and mixed therein. One side of the chamber 21 is formed with an opening 22. A locking cover 23 is provided on the opening 22. A mixing pipe 24 is connected to the chamber 21. The other end of the mixing pipe 24 is connected to a burner nozzle 25. The interior of the chamber 21 is provided with check ring 30. The check ring 30 is made into a hollow cylindrical body by stainless powder alloys. Both sides of the check ring 30 are provided with a sealing gasket 31 respectively. The interior of one end of the mixing pipe 24 adjacent to the burner nozzle 25 is provided with a guiding piece 40 as shown in FIG. 3. The guiding piece 40 is an elongate piece and twisted to form a spiral piece as shown in FIG. 4. A mixed gas of the oxygen and the fuel gas in the mixing pipe 24 can be guided to flow along a spiral path of the guiding piece 40 into the burner nozzle 25.

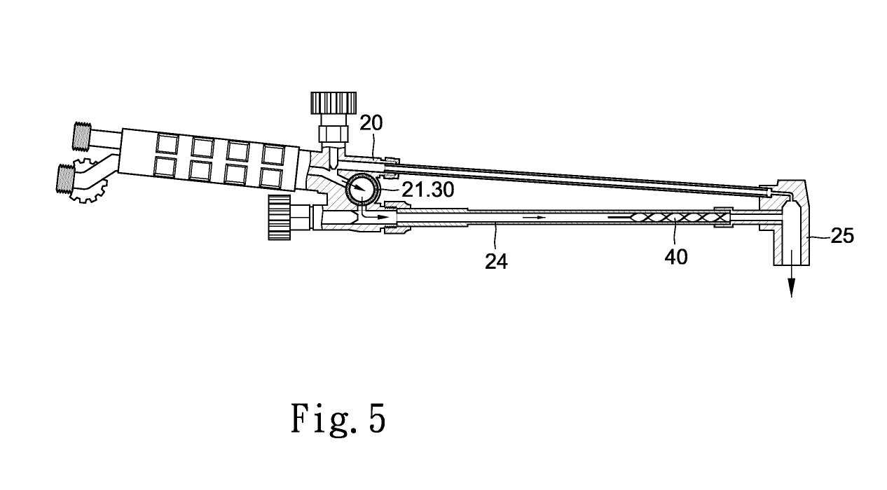

By the above structure, as shown in FIG. 5, since the check ring 30 is made into a hollow cylindrical body by powder alloys, the check ring 30 has a great number of apertures. When the oxygen and the fuel gas are introduced into the chamber 21, the oxygen and the fuel gas permeate into the chamber 21 via the apertures of the check ring 30 and then enter the mixing pipe 24 to be mixed therein. The mixed gas of the oxygen and the fuel gas is exhausted via the burner nozzle 25 for combustion.

Further, since the guiding piece 40 is provided in the mixing pipe 24, the mixed gas of the oxygen and the fuel gas can flow along the spiral path of the guiding piece 40 to be mixed more completely, thereby increasing the efficiency in combustion. Since the spiral path of the guiding piece 40 has a larger length, if the flame flows back into the mixing pipe 24 to generate a backfire, the operator has enough time to shut off the supply of the fuel gas to thereby prevent the flame from burning deeper into the mixing pipe 24. If the flame accidentally burns back into the chamber 21, the flame can be blocked by the check ring 30. As a result, the flame is extinguished, so that the gas explosion in the chamber 21 due to the backfire can be prevented.

According to the above description and drawings, since the check ring is provided in the chamber, and the guiding piece is provided in the mixing pipe, the flame can be prevented from burning back into the chamber to generate a backfire. Thus, the present invention really improves the problems in prior art and demonstrates inventive steps. Further, the structure of the present invention has not been seen in public and thus has novelty. Thus, the present invention conforms to the requirements for an invention patient.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A cutting and welding torch, including a base provided with a chamber for allowing oxygen and a fuel gas to be introduced and mixed therein, one side of the chamber being formed with an opening, a locking cover being provided on the opening, a mixing pipe being connected to the chamber, the other end of the mixing pipe being connected to a burner nozzle,
wherein the interior of the chamber is provided with a check ring, both sides of the check ring are provided with a sealing gasket respectively, the check ring is made into a hollow cylindrical body by powder alloys, the inside of one end of the mixing pipe adjacent to burner nozzle is provided with a guiding piece, the guiding piece is an elongate metallic piece and twisted to form a spiral piece, a mixed gas of the oxygen and the fuel gas flows along a spiral path of the guiding piece.
